(19) United States
(12) Patent Application Publication
(10) Pub. No.: US 2025/0273665 A1
(43) Pub. Date: Aug. 28, 2025

(54) POSITIVE ELECTRODE ACTIVE MATERIAL AND ALL-SOLID-STATE SECONDARY BATTERY COMPRISING SAME

(71) Applicant: L&F CO., LTD., Daegu (KR)

(72) Inventors: Jae Yeong PARK, Daegu (KR); Hye Yun JUNG, Daegu (KR); Ji Hyun SHIN, Daegu (KR); Eun Ju LEE, Daegu (KR); Sun Hye LIM, Daegu (KR); Sung Kyun CHANG, Daegu (KR); Doe Hyoung KIM, Daegu (KR)

(21) Appl. No.: 18/685,273

(22) PCT Filed: Aug. 31, 2022
(86) PCT No.: PCT/KR2022/013069

§ 371 Date: Aug. 7, 2024

(30) Foreign Application Priority Data
Sep. 3, 2021 (KR) 10-2021-0117651

(51) Int. Cl. H01M 4/525; H01M 4/02; H01M 10/0562

(52) U.S. Cl. CPC H01M 4/525; H01M 10/0562; H01M 2004/021; H01M 2004/028; H01M 2300/0065

(57) ABSTRACT

Disclosed is a cathode active material for an all-solid-state secondary battery, wherein, when comparing volume versus particle size distribution (PSD) graphs before and after pressing under the following pressing condition, the condition of the following Equation 1 is satisfied at point A corresponding to a diameter of particles having a maximum occupied volume before pressing on an X-axis of the graph.

$$Z = ( volume \% of particles at point A after pressing / volume \% of particles at point A before pressing ) \times 100 \qquad [ Equation 1 ]$$

Z≥70% [Pressing condition]

The active material is pressed at 4.5 tons per unit area (cm²).

### TECHNICAL FIELD

The present invention relates to a cathode active material and more particularly, to a cathode active material that exhibits excellent battery characteristics by satisfying specific particle diameter and volume distribution conditions before and after pressing in a secondary battery manufacturing process, and an all-solid-state secondary battery including the same.

### BACKGROUND ART

Lithium secondary batteries are widely used in various fields such as mobile devices, energy storage systems, and electric vehicles due to high energy density and voltage, long cycle lifespan, low self-discharge rate and the like.

In general, among lithium secondary batteries, non-aqueous electrolyte secondary batteries are widely used and all-solid-state secondary batteries have also been actively developed recently.

In the process of manufacturing such a lithium secondary battery, “pressing” is required, which involves mixing raw materials such as a cathode active material, a binder, and a conductive material, and then pressing the resulting mixture at a predetermined pressure using a device such as a roll-press in order to improve energy density.

However, the high pressure applied during pressing may cause the problem of breakage of the particles, which is one of the main causes of deterioration of battery characteristics. In particular, all-solid-state secondary batteries are pressed at a higher pressure in order to improve interfacial contact with the cathode active material since the electrolyte is used as a solid rather than a liquid, resulting in the problem of particle breakage compared to non-aqueous electrolyte secondary batteries.

On the other hand, it may be fundamentally impossible to prevent particle breakage in terms of the characteristics of the active material particles and the pressing process.

Therefore, there is an increasing need to develop a cathode active material in consideration of this overall situation.

### DISCLOSURE

### Technical Problem

Therefore, the present invention has been made to solve the above and other technical problems that have yet to be solved.

Therefore, as a result of extensive research and various experiments, the present inventors tracked changes in active material particles before and after pressing, especially changes in diameter and volume distribution of active material particles during the secondary battery manufacturing process in various aspects and found that excellent battery characteristics can be obtained when these factors satisfy the specific conditions. Based on this finding, the present invention was completed.

### Technical Solution

In accordance with an aspect of the present invention, provided is a cathode active material for an all-solid-state secondary battery, wherein, when comparing volume versus particle size distribution (PSD) graphs before and after pressing under the following pressing conditions, the condition of the following Equation 1 is satisfied at point A corresponding to the diameter of the particles having a maximum occupied volume before pressing on the X-axis of the graph.

$$Z = ( volume \% of particles at point A after pressing / volume \% of particles at point A before pressing ) \times 100 \qquad [ Equation 1 ]$$

Z≥70% [Pressing condition]

The active material is pressed at 4.5 tons per unit area (cm²).

As described above, when the active material powder is pressed in the process of preparing a cathode active material, the particles are broken by the applied pressure and thus change in volume.

Specifically, since a cathode active material having a secondary particle structure has an aggregated structure of primary particles, the weakly bonded primary particles are desorbed or the secondary particles are broken into several fragments, and thus the number of relatively small particles increases.

The cathode active material present as a non-aggregated single particle has a single particle structure rather than an aggregated structure, but some particles are weakly aggregated due to technical limitations, and these weakly aggregated particles are desorbed or one-body particles are broken into several fragments when pressed, resulting in an increase in number of relatively small particles.

In this case, the phenomenon in which, not only particles that are substantially broken, but also particles that are weakly bound/aggregated are desorbed by pressing constitute particle breakage, and the term “particle breakage” hereinafter refers to both of these cases. Both the particles that are broken and are split into several fragments and the small particles that are weakly bound/aggregated and then desorbed are defined as fine powder. In other words, the fine powder refers not only to particles with a small diameter, but also to particles whose size has been reduced by pressing. In addition, the criteria for the size of the fine powder are not absolute but relative.

According to the present invention, when comparing the volume distribution of particles before and after pressing in the process of pressing based on a particle size distribution (PSD) graph, excellent battery characteristics were achieved by applying a cathode active material that satisfies the conditions of Equation 1 to an all-solid-state secondary battery.

Data analysis of the PSD graph for the volume distribution of particles is based on the following factors.
Diameter (D): Diameter of a specific particle
Volume (D³): Volume of a specific particle
Number (n): Number of particles with a specific particle size
Occupied volume (O): Volume (D³)×Number (n)
Number %: Number of particles with a specific diameter (D) (n)/Total number of particles×100
Volume %: Occupied volume (O) of particles with a specific diameter (D)/total occupied volume of all particles×100
D50: Particle diameter at 50% of cumulative volume

As described above, particles having the maximum occupied volume refer to particles having the maximum value (occupied volume) when multiplying the volume calculated from a diameter by the number of particles having the diameter. Therefore, although the number of particles is the largest, if each particle has a very small volume, the particles may not correspond to particles having a maximum occupied volume. On the other hand, although the number of particles is relatively small, if each particle has a large volume, the particles may correspond to particles having a maximum occupied volume. Generally, D50 is set as a parameter of an average particle diameter in PSD analysis. D50 refers to a particle diameter corresponding to a cumulative volume of 50% with respect to the total volume (%) of all particles and does not mean that the number of the particles having the corresponding volume are the largest. As such, D50 and occupied volume have different meanings, and thus the diameter with the maximum occupied volume may or may not be equal to the D50 diameter depending on the particle size distribution of the powders. That is, the particle has the highest volume % at the diameter of particles having the maximum occupied volume (point A), but the diameter of particles having the highest volume % (point A) does not mean D50. Therefore, Z satisfying the condition of Equation 1 above does not mean a D50 variation before and after pressing.

Based on this, according to the present invention, in the PSD data analysis before pressing, the position on the X-axis of the PSD graph corresponding to the diameter of the particles with the maximum occupied volume is specified as “point A”, and it is determined whether or not the degree to which the particle volume at point A changes (Z) after pressing satisfies the conditions of Equation 1.

Therefore, Z in Equation 1 is interpreted to mean “occupied volume retention rate before and after pressing of particles having the maximum occupied volume” (hereinafter referred to as “maximum occupied volume retention rate”). Specifically, as Z approaches 100%, particle strength increases and volume change decreases (high retention rate), and as Z moves away from 100%, the particle strength decreases and volume change increases (low retention rate). Therefore, when the particle strength is high, the maximum occupied volume retention rate increases because the number of broken particles is small, and when the particle strength is low, the maximum occupied volume retention rate decreases because the number of broken particles increases. This increase in particle strength can be achieved by changing various reaction conditions in the process of preparing the cathode active material, for example, by increasing the synthesis time while controlling the pH in the coprecipitation for preparing a precursor and doping the cathode active material with an element such as Al or Ti, as shown in the experimental examples described later, but are not limited thereto.

In one specific example, Z, the maximum occupied volume retention rate, may be 70% or more and 100% or less, and an example of Z can be seen from the graph of FIG. 1.

As can be seen from FIG. 1, the particle having the maximum occupied volume before pressing decreases in volume while maintaining almost the same diameter after pressing at ‘point A’. As a result, Z, the maximum occupied volume retention rate, exceeds 70%, providing high particle strength and excellent battery characteristics. However, as shown in FIG. 3, when Z exceeds 100%, characteristics deteriorate compared to when Z is 100% or less. In this case, deterioration of characteristics may decrease under appropriate conditions.

On the other hand, the graph of FIG. 2 shows an example in which Z, the maximum occupied volume retention rate, is less than 70%. As can be seen from FIG. 2, particles having the maximum occupied volume before pressing have reduced diameter and volume after pressing, resulting in the maximum occupied volume retention rate, Z, being less than 70%. Such a cathode active material is not preferred due to the difficulty in providing excellent battery characteristics.

In some cases, when the particles are broken by pressing, Z may exceed 100% depending on the size of broken particles, which can be seen from an example shown in FIG. 3.

It can be seen from FIG. 3 that particles having the maximum occupied volume before pressing have a decreased diameter and increased volume after pressing and have Z, the maximum occupied volume retention rate exceeding 100%.

The maximum occupied volume retention rate exceeds 100% because the particles having the maximum occupied volume before pressing are broken by pressing and the number of particles having the corresponding diameter decreases, but the particles broken by pressing have a specific relatively small diameter. Particle breakage is generally undesirable, but excellent characteristics can be obtained if the size shift is within a limited range, although these characteristics are not better compared to when Z satisfies the condition of 70% to 100%.

However, it is not preferable that the particles are broken into small fragments with a size of 1 μm or less due to low particle strength, the fine powder increases rapidly and the maximum occupied volume retention rate exceeds 100%.

In one specific example, the cathode active material according to the present invention may satisfy the condition of Equation 2 below.

$$Y = ( diameter of particles having a maximum occupied volume after pressing / diameter of particles having a maximum occupied volume before pressing ) \times 100 \qquad [ Equation 2 ]$$

Y≥70%

In other words, the degree to which the diameter of the particles having the maximum occupied volume before pressing is maintained after pressing (hereinafter referred to as “maximum occupied volume diameter retention rate”) is preferably a predetermined level or higher.

The result of in-depth analysis by the present applicant showed that, when Equation 1 is satisfied and Y, the maximum occupied volume diameter retention ratio, is 70% or more, battery characteristics (such as charging/discharging capacity, efficiency, lifespan, safety, resistance, and thermal stability.) are further improved. Referring to FIG. 3 in relation to the conditions of Equation 2, the cathode active material of FIG. 3 satisfies the condition of Y (maximum occupied volume diameter retention rate) of 70% or more, and at the same time, the condition of Z (maximum occupied volume retention rate) higher than 100%.

In another specific example, the cathode active material according to the present invention may satisfy the conditions of Equation 3 below.

$$W = ( volume \% of newly observed peak in small particle area after pressing / volume \% of particles at A before pressing ) \times 100 \qquad [ Equation 3 ]$$

W≤20%

wherein the small particle area is an area where a particle diameter is 1 μm or less.

An example related to the conditions of Equation 3 above will be described with reference to FIG. 4. It can be seen from FIG. 4 that a peak not observed in the small particle area (for example, 1 m or less) before pressing is newly observed after pressing. This is because the occupied volume of small particles increases as the particles are broken by pressing. This results from the fact that particles having a low particle strength are broken into small fragments.

When the particle size decreases as the particles are broken, the degree of deterioration in battery characteristics may vary depending on the size of broken particles. As shown in FIG. 4, when the occupied volume of small particles greatly increases, the battery characteristics may be greatly deteriorated. Therefore, the occupied volume increase rate of the peak newly observed in the small particle region after pressing is preferably within a predetermined range. The result of in-depth analysis by the present applicant showed that, when the occupied volume increase rate of the newly observed peak exceeds 20%, the battery characteristics rapidly deteriorate.

Preferably, the cathode active material according to the present invention is applied to all-solid-state secondary batteries. As described above, since all-solid-state secondary batteries are pressed at a higher pressure in order to improve the interfacial contact between the solid electrolyte and the cathode active material, when the cathode active material having a higher particle strength than a cathode active material applied to non-aqueous electrolyte secondary batteries is applied to all-solid-state secondary batteries, superior characteristics can be secured.

The cathode active material according to the present invention may have a secondary structure of aggregated primary particles or a non-aggregated one-body particle structure. The average particle diameter (D50) of the cathode active material may be, for example, in the range of 1 to 20 μm.

The secondary particle structure has a relatively high probability of breaking along the primary particle interface when pressed because the primary particles have an aggregated structure, whereas the non-aggregated one-body structure has a higher particle strength because it is composed of a single particle.

In one preferred example, when the cathode active material has a non-aggregated one-body particle structure, the condition of Equation 1 that Z is 80% or more, the condition of Equation 2 that Y is 80% or more, the condition of Equation 3 that W is 10% or less and the like are more preferred. This means that the maximum occupied volume retention rate (Z) and the maximum occupied volume diameter retention rate (Y) before and after pressing are very high, and the occupied volume increase rate (W) at the newly observed peak in the small particle region is very low. It can be seen that better characteristics can be obtained.

As described above, particle breakage should be minimized even at higher pressures since all-solid-state secondary batteries are pressed at a higher pressure compared to non-aqueous electrolyte secondary batteries.

The cathode active material having a secondary particle structure according to the present invention has Z of 70% or more in Equation 1 when pressed at 4.5 tons, and Z of 60% or more when pressed at an increased pressure of 5 tons. Therefore, the condition of 60%≤Z may be set in Equation 1 when pressed at an increased pressure of 5 tons in the cathode active material having a secondary structure including aggregated primary particles.

On the other hand, the condition of Equation 1 of the cathode electrode active material having a non-aggregated one-body particle structure when the pressure during pressing is increased to 5 tons may be set to 75%≤Z. In addition, when the pressure during pressing is increased to 6 tons, the condition of Equation 1 may be set to 60%≤Z.

As can be seen in the experimental results described later, the cathode electrode active material according to the present invention that satisfies the conditions exhibits considerably excellent properties in all-solid-state secondary batteries after pressing compared to non-aqueous electrolyte secondary batteries.

For reference, the pressing may be performed using, for example, an Autopellet 3887NE.L from Carver.

The elemental composition of the cathode active material according to the present invention may be represented, for example, by the following Formula (4).

LiₐM_{b}D_{c}Oₓ (4)
wherein
M includes at least one of Ni, Co, and Mn,
D includes at least one selected from alkali metals excluding lithium, alkaline earth metals, transition metals in Groups 3 to 12 excluding nickel, cobalt and manganese, post-transition metals and metalloids in Groups 13 to 15, and non-metallic elements in Groups 14 to 16, and
a, b, c and x satisfy 0.9≤a≤2.0, 0<b≤1, 0≤c≤0.5, and 0<x≤8, respectively.

The alkali metal other than lithium may be, for example, Na, K, Rb, Cs, Fr, or the like, the alkaline earth metal may be, for example, Be, Mg, Ca, Sr, Ba, Ra, or the like, the transition metal of Groups 3 to 12 excluding and nickel, cobalt, and manganese may be, for example, Sc, Ti, V, Cr, Fe, Cu, Zn, Y, Zr, Nb, Mo, Tc, Ru, Rh, Pd, Ag, Cd, Hf, Ta, W, Re, Os, Ir, Pt, Au, Hg, or the like, the post-transition metal and metalloid in Groups 13 to 15 may be, for example, Al, Ga, In, Sn, Tl, Pb, Bi, Po, B, Si, Ge, As, Sb, Te, At, or the like, and the non-metallic element in Groups 14 to 16 may be, for example, C, P, S, Se, or the like. The transition metal element may include a lanthanide group element or an actinium group element.

In one preferred example, D may include at least one selected from the group consisting of Zr, Ti, W, B, P, Al, Si, Mg, Zn, and V.

The present invention also provides an all-solid-state secondary battery containing a cathode active material. The configuration and production method of the all-solid-state secondary battery are known in the art, and thus a detailed description thereof will be omitted herein.

### Effects of the Invention

As described above, when the cathode active material satisfies the specific conditions according to the present invention during pressing in the process of manufacturing secondary batteries, it is preferably used in an all-solid-state secondary battery that requires high pressing.

### DESCRIPTION OF THE DRAWINGS

FIG. 1 is a PSD graph illustrating an exemplary cathode active material satisfying the condition that a maximum occupied volume retention rate (Z) is not less than 70% and not more than 100%;

FIG. 2 is a PSD graph illustrating an exemplary cathode active material according to the present invention having a maximum occupied volume retention (Z) of less than 70% in Equation 1;

FIG. 3 is a PSD graph illustrating an exemplary cathode active material according to the present invention having a maximum occupied volume retention (Z) greater than 100% in Equation 1; and

FIG. 4 is a PSD graph illustrating an exemplary cathode active material according to the present invention having a small particle region after pressing in Equation 3.

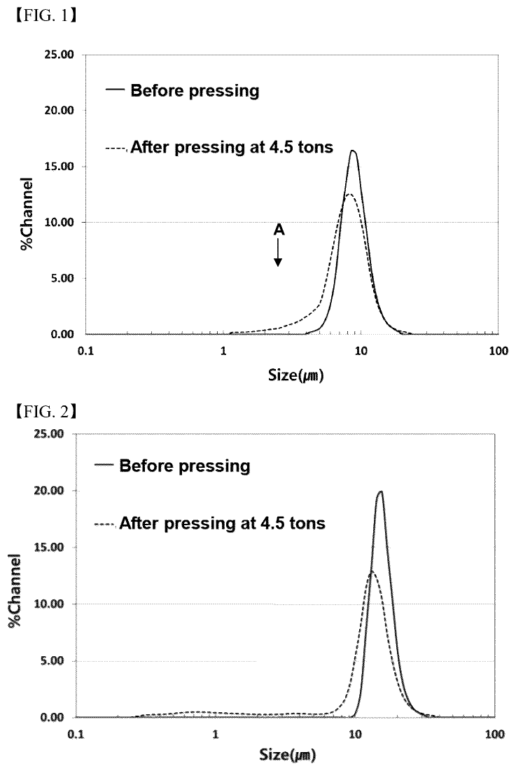

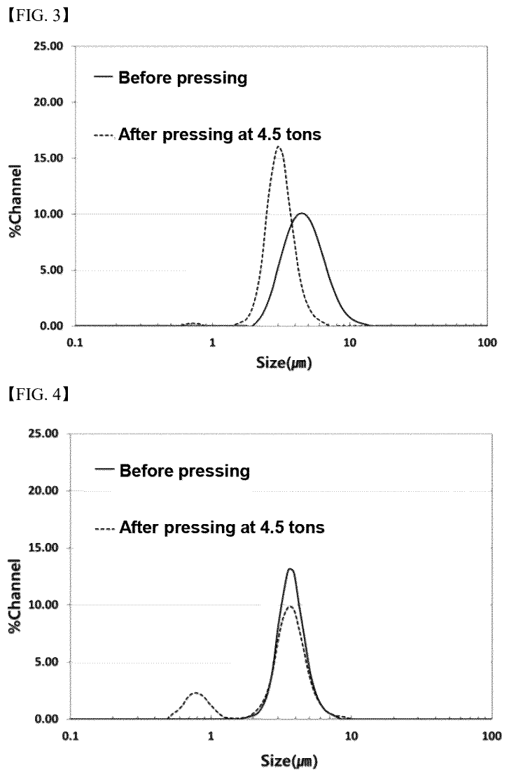

### BEST MODE

Now, the present invention will be described in more detail with reference to the following examples. These examples should not be construed as limiting the scope of the present invention.

### Comparative Example 1

Caustic soda and ammonia were added to a 500 L cylindrical reactor and the initial pH was adjusted to 11.7 to 11.9. Then, an aqueous metal salt solution with a Ni:Co:Mn ratio of 70:15:15 was continuously supplied along with an aqueous solution of caustic soda and ammonia, the pH of the synthesis product in the reactor was adjusted to 11.0 to 11.5, the ammonia concentration in the reactor was adjusted to 3,000 to 6,000 ppm, and synthesis was performed by coprecipitation at 60° C. and at a stirring speed of 530 rpm for 18 hours. As a result, a composite transition metal hydroxide powder having a D50 of 6 to 7 μm was prepared.

The prepared precursor and LiOH were injected into a 10 L mixer (Nippon Coke & Engineering) at a ratio of Li to the metal of 1.01, mixed under the following conditions of 100 rpm/1 min→400 rpm/5 min→500 rpm/15 min, and calcined at 880° C. for 30 minutes to prepare a Li_{1.01}Ni_{0.70}Co_{0.15}Mn_{0.15}O₂ cathode active material.

### Comparative Example 2

A precursor was prepared in the same manner as in Example 1, except that caustic soda and ammonia were initially added to adjust the initial pH to 11.9 to 12.1 in Comparative Example 1. At this time, the synthesis time of the precursor was 22 hours and D50 was 6 to 7 μm. The subsequent active material preparation process was performed in the same manner as in Comparative Example 1.

### Comparative Example 3

Caustic soda and ammonia were added to a 500 L cylindrical reactor and the initial pH was adjusted to 11.7 to 11.9. Then, an aqueous metal salt solution with a Ni:Co:Mn ratio of 90:05:05 was continuously supplied along with an aqueous solution of caustic soda and ammonia, the pH of the synthesis product in the reactor was adjusted to 11.0 to 11.5, the ammonia concentration in the reactor was adjusted to 3,000 to 6,000 ppm, and synthesis was performed by coprecipitation at 60° C. and at a stirring speed of 420 rpm for 21 hours. The prepared precursor has D50 of 10 to 11 μm. Then, the active material preparation process was performed in the same manner as in Comparative Example 1, and the active material calcination temperature was set at 720° C.

### Comparative Example 4

When the precursor prepared in Comparative Example 3 and LiOH were mixed at a ratio of Li/Me=1.01, TiO₂ was mixed with the precursor at a weight ratio of TiO₂ to the precursor of 0.48. Then, the active material preparation process was performed in the same manner as in Comparative Example 3.

### Comparative Example 5

In the precursor preparation process of Comparative Example 3, the initial pH was adjusted to 12.3 to 12.5, and the pH of the synthesis product in the reactor was adjusted to 11.5 to 12.0. The ammonia concentration in the reactor was adjusted to 6,000 to 8,000 and synthesis was performed by coprecipitation at 60° C. and at a stirring speed of 530 rpm for 34 hours. As a result, a composite transition metal hydroxide powder having a D50 of 4 to 5 μm was prepared. Then, the subsequent calcination was performed in the same manner as in Comparative Example 3.

### Comparative Example 6

In the precursor preparation process of Comparative Example 3, the initial pH was adjusted to 12.1 to 12.3, and the pH of the synthesis product in the reactor was adjusted to 11.5 to 12.0. The ammonia concentration in the reactor was adjusted to 6,000 to 8,000 and synthesis was performed by coprecipitation at 60° C. and at a stirring speed of 530 rpm for 34 hours. As a result, a composite transition metal hydroxide powder having a D50 of 4 to 5 μm was prepared. Then, the subsequent calcination was performed in the same manner as in Comparative Example 3.

### Example 1

A precursor was prepared in the same manner as in Comparative Example 1, except that caustic soda and ammonia were initially added to adjust the initial pH to 12.1 to 12.3 in Comparative Example 1. At this time, the synthesis time of the precursor was 28 hours and D50 was 6 to 7 μm. The subsequent active material preparation process was performed in the same manner as in Comparative Example 1.

### Example 2

When the precursor prepared in Comparative Example 1 and LiOH were mixed at a ratio of Li/Me=1.01, Al(OH)₃ was added thereto and mixed at a weight ratio of Al(OH)₃ to the precursor of 0.87. Then, the subsequent active material preparation process was performed in the same manner as in Comparative Example 1.

### Example 3

When the precursor prepared in Comparative Example 1 and LiOH were mixed at a ratio of Li/Me=1.01, Al(OH)₃ was added thereto and mixed at a weight ratio of Al(OH)₃ to the precursor of 1.74. Then, the subsequent active material preparation process was performed in the same manner as in Comparative Example 1.

### Example 4

Caustic soda and ammonia were added to a 500 L cylindrical reactor and the initial pH was adjusted to 12.1 to 12.3. Then, an aqueous metal salt solution with a Ni:Co:Mn ratio of 75:10:15 was continuously supplied along with an aqueous solution of caustic soda and ammonia to prepare a precursor and the precursor synthesis time was 26 hours. The subsequent active material preparation process was performed in the same manner as in Comparative Example 1.

### Example 5

Caustic soda and ammonia were added to a 500 L cylindrical reactor and the initial pH was adjusted to 12.1 to 12.3. Then, an aqueous metal salt solution with a Ni:Co:Mn ratio of 80:10:10 was continuously supplied along with an aqueous solution of caustic soda and ammonia to prepare a precursor and the precursor synthesis time was 30 hours. The subsequent active material preparation process was performed in the same manner as in Comparative Example 1 and the active calcination temperature was 800° C.

### Example 6

A precursor was prepared in the same manner as in Comparative Example 3, except that the initial pH was adjusted to 12.1 to 12.3 in the process of preparing a precursor in Comparative Example 3. At this time, the synthesis time of the precursor was 30 hours and D50 was 10 to 11 μm. The subsequent active material preparation process was performed in the same manner as in Comparative Example 3.

### Example 7

A precursor was prepared in the same manner as in Comparative Example 3, except that the initial pH was adjusted to 11.9 to 12.1 in the process of preparing a precursor in Comparative Example 3. At this time, the synthesis time of the precursor was 25 hours and D50 was 10 to 11 μm. The subsequent active material preparation process was performed in the same manner as in Comparative Example 3.

### Example 8

When the precursor prepared in Comparative Example 3 and LiOH were mixed at a ratio of Li/Me=1.01, TiO₂ was mixed with the precursor at a weight ratio of TiO₂ to the precursor of 1.44. Then, the active material preparation process was performed in the same manner as in Comparative Example 3.

### Example 9

When the precursor prepared in Comparative Example 3 and LiOH were mixed at a ratio of Li/Me=1.01, TiO₂ was mixed with the precursor at a weight ratio of TiO₂ to the precursor of 0.96. Then, the active material preparation process was performed in the same manner as in Comparative Example 3.

### Example 10

In the precursor preparation process of Comparative Example 3, the initial pH was adjusted to 12.5 to 12.7, and the pH of the synthesis product in the reactor was adjusted to 11.5 to 12.0. The ammonia concentration in the reactor was adjusted to 6,000 to 8,000 and synthesis was performed by coprecipitation at 60° C. and at a stirring speed of 530 rpm for 40 hours. As a result, a composite transition metal hydroxide powder having a D50 of 4 to 5 μm was prepared. Then, the subsequent calcination was performed in the same manner as in Comparative Example 3.

### Experimental Example 1

A pressure of 4.5 tons per unit area (cm²) was applied to the particles of the cathode active material prepared in Comparative Examples 1 to 6 and Examples 1 to 10 using an Autopellet 3887NE.L (Carver). The change in particle size distribution before and after pressing was measured, and Z, Y, and W of the following Equations 1 to 3 were calculated and shown in Table 1.

$$Z = ( volume \% of particles at point A after pressing / volume \% of particles at point A before pressing ) \times 100 \qquad [ Equation 1 ]$$

$$Y = ( diameter of particles having a maximum occupied volume after pressing / diameter of particles having a maximum occupied volume before pressing ) \times 100 \qquad [ Equation 2 ]$$

$$W = ( volume \% of newly observed peak in small particle area after pressing / volume \% of particles at A before pressing ) \times 100 \qquad [ Equation 3 ]$$

TABLE 1

| | Z | Y | W |
|---|---|---|---|
| Comparative Example 1 | 54.12% | 60.21% | 23.20% |
| Comparative Example 2 | 65.11% | 72.35% | 22.33% |
| Comparative Example 3 | 60.46% | 58.60% | 7.24% |
| Comparative Example 4 | 63.47% | 60.66% | 5.43% |
| Comparative Example 5 | 68.62% | 66.68% | 27.30% |
| Comparative Example 6 | 52.46% | 61.44% | 33.75% |
| Example 1 | 72.35% | 78.31% | 5.12% |
| Example 2 | 72.08% | 68.72% | 0.82% |
| Example 3 | 78.33% | 70.25% | 0.02% |
| Example 4 | 83.21% | 82.11% | 0.02% |
| Example 5 | 83.45% | 88.35% | 0.06% |
| Example 6 | 80.43% | 80.26% | 0.04% |
| Example 7 | 71.54% | 67.36% | 0.06% |
| Example 8 | 83.57% | 86.48% | 0.02% |
| Example 9 | 72.57% | 65.10% | 0.02% |
| Example 10 | 71.57% | 73.66% | 17.46% |

In all of Comparative Examples 1 to 6, Z was less than 70% and did not satisfy the conditions of Equation 1. In Comparative Example 2, only Y satisfied the conditions of Equation 2, and in Comparative Examples 3 and 4, only W satisfied the conditions of Equation 3.

On the other hand, in Examples 1 to 10, Z was 70% or more and thus satisfied at least the condition of Equation 1.

Whether or not these conditions are satisfied causes differences in the performance of the secondary battery in Experimental Example 2 described later.

### Experimental Example 2

(Manufacture of all-Solid-State Secondary Batteries)

To manufacture an all-solid-state secondary battery, the cathode active material prepared in each of Comparative Examples 1 to 6 and Examples 1 to 10, a solid electrolyte (Li₆PS₅Cl) and a conductive material (Super-P) were dry-mixed at a weight ratio of 70:25:5 to prepare a cathode active material composite. Li foil and In foil were used as counter electrodes (anodes).

An all-solid-state secondary battery having a diameter of 10 mm and including a rod current collector and a mold was manufactured as follows.

First, the solid electrolyte (Li₆PS₅Cl) was pressed at 170 MPa to form an SE layer (solid electrolyte layer). Then, the cathode active material composite was applied to one surface of the SE layer and a counter electrode (Li foil, In foil) was applied to the other surface of the SE layer to manufacture an electrode assembly, followed by pressing at 240 MPa to produce an all-solid-state secondary battery.

### (Manufacture of Liquid Electrolyte Secondary Battery)

An electrode assembly was manufactured by using the cathode active material prepared in Comparative Examples 1 to 6 and Examples 1 to 10 and Li metal as an anode and interposing a porous polyethylene film as a separator therebetween, the electrode assembly was placed in a battery case, and an electrolyte solution was injected into the inside of the battery case to manufacture a liquid electrolyte secondary battery.

The electrolyte used herein was prepared by dissolving 1.0 M lithium hexafluorophosphate (LiPF₆) in an organic solvent containing vinylene carbonate (VC: 2 wt %), in addition to ethylene carbonate/dimethyl carbonate/diethyl carbonate (mixed at a volume ratio of EC/DMC/DEC=1/2/1).

### (Charge-Discharge Test)

The all-solid-state secondary battery and liquid electrolyte secondary battery prepared above were aged at room temperature for 12 hours and then a charge-discharge test was performed. Capacity test was based on 200 mAh/g at a rate of 0.1 C and charge-discharge was performed at constant current (CC)/constant voltage (CV) in the voltage range of 4.3 to 2.7 V. The results are shown in Table 2 below.

TABLE 2

| | All-solid-state secondary battery | | | Liquid electrolyte secondary battery | | |
|---|---|---|---|---|---|---|
| | Charge | Discharge | | Charge | Discharge | |
| | capacity | capacity | Efficiency | capacity | capacity | Efficiency |
| | (mAh/g) | (mAh/g) | (%) | (mAh/g) | (mAh/g) | (%) |
| Comparative | 197.83 | 137.42 | 69.46 | 211.36 | 190.08 | 89.93 |
| Example 1 | | | | | | |
| Comparative | 199.75 | 141.43 | 70.80 | 211.66 | 190.14 | 89.83 |
| Example 2 | | | | | | |
| Example 1 | 204.28 | 157.48 | 77.09 | 211.78 | 190.42 | 89.91 |
| Example 2 | 203.84 | 163.48 | 80.20 | 212.62 | 191.44 | 90.04 |
| Example 3 | 210.78 | 165.23 | 78.39 | 211.09 | 190.80 | 90.39 |
| Example 4 | 222.92 | 175.98 | 78.94 | 215.77 | 195.84 | 90.76 |
| Example 5 | 226.42 | 186.31 | 82.29 | 220.23 | 200.44 | 91.01 |
| Example 6 | 235.21 | 194.25 | 82.59 | 236.20 | 227.16 | 96.17 |
| Example 7 | 230.42 | 188.63 | 81.86 | 236.48 | 227.82 | 96.34 |
| Comparative | 219.43 | 177.69 | 80.98 | 236.04 | 227.20 | 96.25 |
| Example 3 | | | | | | |
| Example 8 | 234.96 | 213.57 | 90.90 | 236.19 | 227.51 | 96.32 |
| Example 9 | 231.64 | 208.43 | 89.98 | 237.48 | 228.10 | 96.05 |
| Comparative | 220.19 | 181.42 | 82.39 | 236.81 | 227.98 | 96.27 |
| Example 4 | | | | | | |
| Example 10 | 243.20 | 205.10 | 84.33 | 234.18 | 224.68 | 95.94 |
| Comparative | 227.71 | 174.03 | 76.43 | 233.81 | 224.08 | 95.84 |
| Example 5 | | | | | | |
| Comparative | 226.25 | 170.81 | 75.50 | 233.78 | 222.15 | 95.03 |
| Example 6 | | | | | | |

It can be seen from the experimental results of Table 2 along with Table 1, in Examples 6 and 7 and Comparative Example 3, precursors having a D50 of 10 to 11 μm were prepared for different reaction times by controlling the amount of ammonia and caustic soda. Then, when precursors prepared from particles having the same particle size for different reaction times using the same active material calcination process were used, the difference in particle strength of the cathode active material was determined. To determine the particle strength, the cathode active material was pressed at 4.5 tons and the particle strength was compared before and after pressing.

As a result, in Example 6, Z, Y, and W all satisfied the conditions within the range, exhibiting the highest all-solid-state secondary battery performance. The performance of the all-solid-state secondary battery in Example 7 deteriorated because Y did not satisfy the conditions within the range, but was good, compared to Comparative Example 3 in which Z and Y did not satisfy the conditions within the range. This indicates that the particle strength increases in the order of Example 6>Example 7>Comparative Example 3, and there is no difference in performance when using a liquid electrolyte, but there is a difference in performance in the order of particle strength when applied to an all-solid secondary battery.

In Comparative Example 4 and Examples 8 and 9, cathode active materials were prepared by adding TiO₂ to the precursor prepared in Comparative Example 3. The content of TiO₂ increases in the order of Comparative Example 4<Example 9<Example 8. In Example 8, all Z, Y, and W were satisfied, and the performance was the best when applied to an all-solid-state secondary battery. These results show that, when TiO₂ is used as a predetermined amount or more, the particle strength of the cathode active material is greatly improved, and thus the performance of the all-solid-state secondary battery is also improved.

In Example 10 and Comparative Examples 5 and 6, the reaction time was adjusted by adjusting the initial amounts of ammonia and caustic soda when preparing a precursor with a D50 of 4 to 5 μm. In Comparative Examples 5 and 6, excluding Example 10, Z, Y, and W did not satisfy the conditions within the range and exhibited low performance in all-solid-state secondary batteries.

These results show that there is almost no difference in charge capacity, discharge capacity, and efficiency characteristics in liquid electrolyte secondary batteries depending on whether or not Equations 1 to 3 of the present invention are satisfied, whereas there is a big difference in performance in all-solid secondary batteries depending on whether or not Equations 1 to 3 of the present invention are satisfied.

The difference in performance is because, in a liquid electrolyte secondary battery, even if the particles are broken, the liquid electrolyte can be impregnated into the destroyed active material particles to provide a lithium movement path, whereas, in a solid electrolyte secondary battery (all-solid secondary battery), contact between the electrolyte and the inside of the broken active material particles is blocked, and the lithium movement path is blocked, leading to capacity loss. Therefore, as presented in the present invention, it can be seen from reinterpretation of the PSD graph based on the degree of particle brokage before and after pressing that cathode active materials satisfying specific conditions provide excellent all-solid-state secondary battery performance.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A cathode active material for an all-solid-state secondary battery,
wherein, when comparing volume versus particle size distribution (PSD) graphs before and after pressing under the following pressing condition, the condition of the following Equation 1 is satisfied at point A corresponding to a diameter of particles having a maximum occupied volume before pressing on an X-axis of the graph:
$$Z = ( volume \% of particles at point A after pressing / volume \% of particles at point A before pressing ) \times 100 \qquad [ Equation 1 ]$$
Z≥70% [Pressing condition]
The active material is pressed at 4.5 tons per unit area (cm²).

2. The cathode active material according to claim 1, wherein the cathode active material satisfies the condition of Equation 2 below:
$$Y = ( diameter of particles having a maximum occupied volume after pressing / diameter of particles having a maximum occupied volume before pressing ) \times 100 \qquad [ Equation 2 ]$$
Y≥70%

3. The cathode active material according to claim 1, wherein the cathode active material satisfies the condition of Equation 3 below:
$$W = ( volume \% of newly observed peak in small particle area after pressing / volume \% of particles at A before pressing ) \times 100 \qquad [ Equation 3 ]$$
W≤20%
wherein the small particle area is an area where a particle diameter is 1 μm or less.

4. The cathode active material according to claim 1, wherein the cathode active material has a secondary structure including aggregated primary particles.

5. The cathode active material according to claim 1, wherein the cathode active material has a non-aggregated one-body particle structure.

6. The cathode active material according to claim 1, wherein the cathode active material has an average particle diameter (D50) of 1 to 20 μm.

7. The cathode active material according to claim 1, wherein the cathode active material has a non-aggregated one-body particle structure and Z in Equation 1 is 80% or more.

8. The cathode active material according to claim 2, wherein the cathode active material has a non-aggregated one-body particle structure and Y in Equation 2 is 80% or more.

9. The cathode active material according to claim 3, wherein the cathode active material has a non-aggregated one-body particle structure and W in Equation 3 is 10% or less.

10. The cathode active material according to claim 1, wherein the cathode active material has a secondary structure including aggregated primary particles and the condition of Equation 1 is set to Z≥60% when the pressure during pressing increases to 5 tons.

11. The cathode active material according to claim 1, wherein the cathode active material has a non-aggregated one-body particle structure and the condition of Equation 1 is set to Z≥75% when the pressure during pressing increases to 5 tons.

12. The cathode active material according to claim 1, wherein the cathode active material is represented by the following Formula (4).
LiₐM_{b}D_{c}Oₓ (4)
wherein
M includes at least one of Ni, Co, and Mn,
D includes at least one selected from alkali metals excluding lithium, alkaline earth metals, transition metals in Groups 3 to 12 excluding nickel, cobalt and manganese, post-transition metals and metalloids in Groups 13 to 15, and non-metallic elements in Groups 14 to 16, and
a, b, c and x satisfy 0.9≤a≤2.0, 0<b≤1, 0≤c≤0.5, and 0<x≤8, respectively.

13. An all-solid-state secondary battery comprising the cathode active material according to claim 1.
